(19) United States
(12) Patent Application Publication
(10) Pub. No.: US 2024/0169708 A1
(43) Pub. Date: May 23, 2024

(54) PROCESSING VIDEO DATA USING DELTA QUANTIZATION

(71) Applicant: QUALCOMM Incorporated, San Diego, CA (US)

(72) Inventors: Davide ABATI, Amsterdam (NL); Amirhossein HABIBIAN, Amsterdam (NL); Markus NAGEL, Amsterdam (NL)

(21) Appl. No.: 18/338,184

(22) Filed: Jun. 20, 2023

Related U.S. Application Data
(60) Provisional application No. 63/383,156, filed on Nov. 10, 2022.

(51) Int. Cl. G06V 10/776; G06V 10/77; G06V 20/40; G06V 10/82

(52) U.S. Cl. CPC G06V 10/776; G06V 10/7715; G06V 20/46; G06V 10/82

(57) ABSTRACT

Certain aspects of the present disclosure provide techniques and apparatus for delta quantization for video processing and other data streams with temporal content. An example method generally includes receiving image data including at least a first frame and a second frame, generating a first convolutional output based on a first frame using a machine learning model, generating a second convolutional output based on a difference between the first frame and the second frame using one or more quantizers of the machine learning model, generating a third convolutional output associated with the second frame as a combination of the first convolutional output and the second convolutional output, and performing image processing based on the first convolutional output and the third convolutional output.

### CROSS-REFERENCE TO RELATED APPLICATIONS

This application claims benefit of and priority to U.S. Provisional Patent Application Ser. No. 63/383,156, entitled “Processing Video Data Using Delta Quantization,” filed Nov. 10, 2022, and assigned to the assignee hereof, the entire contents of which are incorporated by reference herein.

### INTRODUCTION

Aspects of the present disclosure relate to using machine learning models to process video content.

Artificial neural networks may be used to perform various operations with respect to video content or other content that includes a spatial component and a temporal component. For example, artificial neural networks can be used to compress video content into a smaller-sized representation to improve the efficiency of storage and transmission, and to match the intended use (e.g., an appropriate resolution of data for the size of a device's display) for the video content. Compression of this content may be performed using lossy techniques such that the decompressed version of the data is an approximation of the original data that was compressed or by using lossless techniques that result in the decompressed version of the data being equivalent to the original data. In another example, artificial neural networks can be used to detect objects in video content. Object detection may include, for example, subject pose estimation used to identify a moving subject in the video content and predict how the subject will move in the future, object classification to identify objects of interest in the video content, and the like.

Generally, the temporal component of video content may be represented by different frames in the video content. Artificial neural networks may process frames in the video content independently through each layer of the artificial neural network. Thus, the cost of video processing through artificial neural networks may grow at a different (and higher) rate than the rate at which information in the video content grows. That is, between successive frames in the video content, there may be small changes between each frame, as only a small amount of data may change during an elapsed amount of time between different frames. However, because neural networks generally process each frame independently, artificial neural networks generally process repeated data between frames (e.g., portions of the scene that do not change), which is highly inefficient and results in a waste of compute resources (e.g., processor cycles, memory utilization, etc.) from repeated processing of unchanged data between different frames.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages as described herein.

Certain aspects provide a method for generating inferences based on quantization of a delta between different portions of an input stream. An example method generally includes receiving image data including at least a first frame and a second frame, generating a first convolutional output based on the first frame using a machine learning model, generating a second convolutional output based on a difference between the first frame and the second frame using one or more quantizers of the machine learning model, generating a third convolutional output associated with the second frame as a combination of the first convolutional output and the second convolutional output, and performing image processing based on the first convolutional output associated with the first frame and the third convolutional output associated with the second frame.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example convolution operation involving different portions of a data stream based on a delta between these different portions, according to aspects of the present disclosure.

FIG. 2 illustrates an example of operations for convolving different portions of a data stream based on quantization of a delta between these different portions of the data stream, according to aspects of the present disclosure.

FIG. 3 illustrates an example of conditional delta quantization of different portions of a data stream based on a delta between these different portions, according to aspects of the present disclosure.

FIG. 4 illustrates an example of pixel-wise conditional delta quantization of different portions of a data stream based on a delta between these different portions, according to aspects of the present disclosure.

FIG. 5 illustrates example operations for delta quantization of different portions of a data stream, according to aspects of the present disclosure.

FIG. 6 illustrates an example system in which aspects of the present disclosure may be implemented.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and apparatus for efficiently processing video data (or other streaming data) based on quantizing deltas, or differences, between different portions of the video data (or other streaming data).

As discussed, artificial neural networks can be used to perform various inference operations on video content. These inferences can be used, for example, in various compression schemes, object detection, computer vision operations, various image processing and modification operations (e.g., upsizing, denoising, etc.), and the like. However, artificial neural networks may process each video frame in video content independently. Thus, these artificial neural networks may not leverage various redundancies across frames in video content.

Processing streaming data using a trained neural network may be a computationally complex task, and computational complexity may scale with the accuracy of the neural network. That is, accurate models may be more computationally complex to train and use, while less accurate models may be less computationally complex to train and use. To allow for improvements in computational complexity while retaining accuracy in artificial neural networks, redundancies in data may be exploited. For example, channel redundancy may allow for weights to be pruned based on various error terms, quantization can be used to represent weights using smaller bit widths, and singular value decomposition can be used to approximate weight matrices with more compact representations. In another example, spatial redundancy can be used to exploit similarities in the spatial domain. In yet another example, knowledge distillation can be used, in which a student neural network is trained to match a feature output of a teacher neural network. However, these techniques may not leverage temporal redundancies in video content or other content including a temporal component.

Aspects of the present disclosure provide techniques and apparatus that leverage temporal redundancies in video content or other content including a temporal component in generating inferences, using a neural network or other machine learning model. These temporal redundancies may be represented by a difference, or delta, between successive portions of the video content or other content with a temporal component. By performing inferences using a neural network based on deltas quantized into lower precisions from successive portions of video content or other content with a temporal component, aspects of the present disclosure can reduce an amount of data used in performing inferences using a neural network. This may accelerate the process of performing inferences using a neural network, which may reduce the number of processing cycles and memory used in these operations, reduce the amount of power used in training and inference operations, and the like.

### Example Delta Quantization for Streaming Data in Artificial Neural Networks

Generally, in processing an input floating-point tensor x, the input tensor x may be quantized into a fixed-point tensor \hat{x} in b bits using a quantization function \hat{x}=q(x; Θ), where Θ represents quantizer parameters used in quantizing the input tensor x. Various quantization functions may be used to quantize x into \hat{x}; for example, using a uniform affine symmetric quantization, the quantization function may be defined according to the equation:

$$q ( s ; Θ ) = s [ clamp ( round ( \frac{x}{s} ) , - {2}^{b - 1} , {2}^{b - 1} - 1 ) ]$$

where the quantizer parameters Θ include a scaling factor s, and where the clamp function restricts the rounded value of

$$\frac{x}{s}$$

between a lower bound of −2^{b-1} and an upper bound of 2^{b-1}−1.

A floating-point convolution function z=w*x may generally be performed in fixed point \hat{z}=ŵ*\hat{x} by quantizing weight and input tensors according to the quantization function above. The rounding and clamping operations introduce a quantization error, defined as ϵ=z−\hat{z}, with smaller quantization errors corresponding to better inference performance.

In a case in which weights are quantized and inputs are not quantized, such that \hat{z}=x*ŵ, the quantization error can be represented by the expression:

ϵ_{w}=x*w−x*ŵ=x*(w−ŵ)

The quantization error on the weights and the magnitude of such an error on an input x may contribute to the overall quantization error. It may be seen that, due to lower variance and magnitude of residual values, convolving such values using quantized weights may exhibit a reduced quantization error relative to convolving other data. Similarly, in a case in which inputs are quantized and weights are not quantized, such that \hat{z}=\hat{x}*w, the quantization error can be represented by the expression:

ϵₓ=(x−\hat{x})*w=Δx*w

Assuming that no clipping is performed, the quantization error may be represented by the expression:

$$Δ x = x - q ( x ; Θ ) = x - s ( round ( \frac{x}{s} ) ) = s ( \frac{x}{s} - round ( \frac{x}{s} ) )$$

and may be bound between the values

$$- \frac{s}{2} and \frac{s}{2} .$$

Because the scaling factor s may be proportional to the magnitude and variance of an input x, quantizing residual values with smaller variances may reduce quantization errors Δx and ϵₓ.

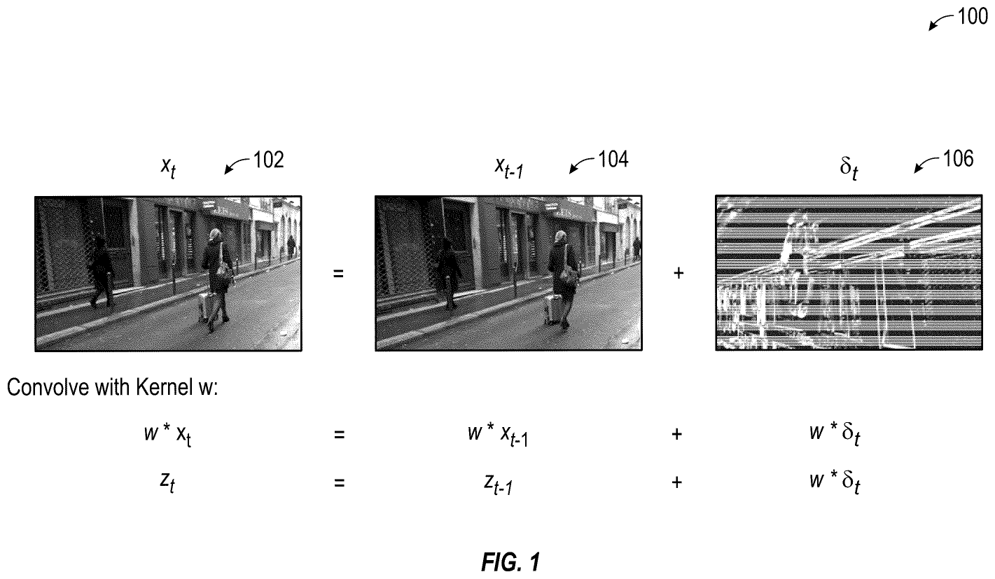

FIG. 1 illustrates an example convolution operation 100 involving different portions of a data stream based on a delta between these different portions, according to aspects of the present disclosure.

As illustrated in FIG. 1 the data stream includes a frame 102 at time t, represented by xₜ, convolved with the kernel w, which may be a convolutional layer of a pre-trained neural network. While FIG. 1 illustrates convolution with respect to video frames, it should be recognized that the techniques described herein may be used to process other types of data having a temporal component. This data may, in some aspects, include one or more spatial components, such as video content in which the spatial components include a height component, a width component, and a channel component (e.g., color channels, such as red/green/blue channels/alpha channels, luminance channels, etc.). The convolution of xₜ with w yields the output zₜ.

A frame at time t may be represented by a sum of a previous frame at time t-1 and a difference (e.g., a delta frame, which may also be referred to as a residual frame) between the frame at time t and the frame at time t-1. Thus, a sum of a convolution of the frame at time t-1 and a convolution of the difference between the frame at time t and the frame at time t-1 yields the convolution of the frame at time t. Thus, the same output, zₜ, may be achieved by convolving a frame 104 at time t-1, represented by xₜ₋₁, with the same kernel w and adding the residual frame 106 convolved with the same kernel w, where the residual frame is defined as the difference between a current frame (e.g., frame 102) and a previous frame (e.g., frame 104). In other words, a current output of the convolution (e.g., the current frame) may be constructed by reusing a previous output (e.g., a previous frame) of the convolution and adding an update given by convolving the residual frame with the kernel. Thus, using the distributive property and the sigma-delta rule, the convolution at frame t may be represented by the following equation:

zₜ=w*xₜ=w*(xₜ₋₁+δₜ)=zₜ₋₁+w*δₜ

where δₜ represents the residual frame 106, which may also be referred to as a delta frame. That is, since the sigma-delta rule allows for a frame at time t to be represented as the sum of a frame at time t-1 and a delta applied to the frame, a convolution at frame t may similarly be represented as the sum of the convolution of the frame at time t-1 and the convolution of the delta between the frame at time t-1 and the frame at time t.

Generating a convolution z in fixed-point representation using quantization functions discussed above may be represented by the equation:

\hat{z}ₜ=q(δₜ;Θₐ)*q(w;Θ_{w})+\hat{z}ₖ

where \hat{z}ₖ represents the quantized convolution for a keyframe (or key input) xₖ, generated according to the equation:

\hat{z}ₖ=q(xₖ;Φₐ)*q(w;Φ_{w})

In the equation above, Φ_{w} and Φₐ represent weight and quantization parameters for keyframes (or key inputs) and may be shared across each of the keyframes in an input stream of video frames. Similarly, Θ_{w} and Θₐ represent weight and quantization parameters for residual frames, and these weight and quantization parameters may be shared across each of the residual frames or dynamically adjusted based on the content of such residual frames, as discussed in further detail below.

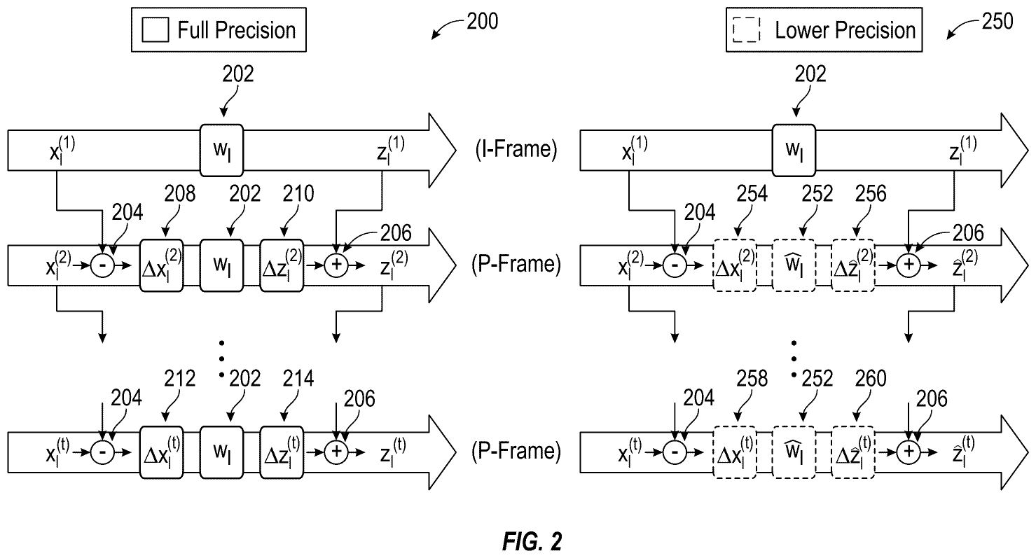

FIG. 2 illustrates examples of operations 200 and 250 for convolving different portions of a data stream based on quantization of a delta between these different portions of the data stream, according to aspects of the present disclosure.

Generally, using quantization may reduce the computational expense, and thus improve the speed at which inferences are performed, when performing inferences using trained neural networks on a processor, such as a neural signal processor (NSP). In some cases, when quantizing models for data streams (e.g., video streams or other data streams having data with temporal components), different frames may be quantized independently. In independently quantizing different frames or other data having temporal components, redundancies may not be exploited between these different frames because each frame is treated as if the data in the frame has not been previously processed, even though potentially significant amounts of successive frames may actually remain the same (or at least substantially the same).

In some aspects, such quantization at a layer l of a neural network may be performed in accordance with the following equation:

\hat{z}ₗ^{(t)}=ŵₗ*xₗ^{(t)}

However, independently quantizing data with a temporal component may ignore temporal redundancies (e.g., by processing each frame independently, including repeated data between frames). Thus, independent processing of successive frames may waste compute resources (e.g., processor cycles, memory utilization, etc.) from repeated processing of unchanged data between different frames.

Aspects of the present disclosure provide techniques and apparatus for leveraging temporal redundancies using delta quantization to improve quantization of video models. In certain cases, temporal redundancies between a first frame and a second frame imply small deltas between the first frame and the second frame. For example, in a video stream captured at a frame rate of 60 frames per second (FPS), each subsequent frame only captures changes that have occurred in the last 1/60^{th} of a second. In some cases, the delta (e.g., the changes that have occurred between video frames) may be very small, since many portions of the scene may be unchanged between frames and since the amount of change that can occur between these frames may be minimal. Such small deltas may result in small quantization error/noise. The quantization error depends on a distribution (e.g., a range) of values. In some cases, weights and/or activations may be stored (e.g., quantized) in lower bit precision than the precision that these values are trained in. For example, floating-point values may be quantized to a fixed set of (scaled) integer values. For example, a continuous set of floating-point values may be sorted into discrete buckets of integer values (e.g., based on proximity to the integer values). Performing quantization reduces memory overhead of storing tensors and reduces the complexity and cost of operations (e.g., matrix multiplication).

Delta quantization of an input at a given layer l of the neural network may be performed in accordance with the following equation:

\hat{z}ₗ^{(t)}=zₗ^{(t-1)}+ŵₗ*(x^{(t)}−x^{(t-1)})

As illustrated in FIG. 2, delta quantization may be performed at a first precision level (e.g., full precision) in accordance with operations 200. Full precision may refer to a data type with a wide range of possible values, such as a 32-bit floating-point data type, which supports a range of values between 1.2*10⁻³⁸ to 3.4*10³⁸. For full precision delta quantization, a convolution for an initial data element (e.g., an independent frame (I-Frame), also referred to as a keyframe, in video content) may be computed by convolving the initial data element x_{I}⁽¹⁾ using kernel 202, thus yielding an output z_{I}⁽¹⁾ as described above with reference to FIG. 1. In some aspects, a subtraction operation 204 may be performed to compute a difference 208 between the initial data element and a second data element (e.g., a P-Frame, or predicted frame) x_{I}⁽²⁾. The difference 208 is also convolved with kernel 202. In some aspects, this subtraction operation 204 may be omitted (e.g., when the data stream is compressed, such that the second data element encodes this difference information and is rendered based on a combination of the initial data element and the second data element). An addition operation 206 may be performed on the result 210 of the convolution and the output of the I-Frame z_{I}⁽¹⁾, thus yielding output z_{I}⁽²⁾. This procedure may be generalized to a t^{th} frame, where a difference 212 between a current frame and a previous frame x_{I}^{(t-1)} may be computed and convolved with kernel 202. The result 214 of the convolution may be added to the output of a previous frame, yielding output z_{I}^{(t)}. According to some aspects, the previous frame may be an I-Frame, or a previous P-Frame.

As illustrated in FIG. 2, delta quantization for P-Frames may be performed at a second precision level (e.g., lower precision) in accordance with operations 250. Lower precision may refer to a data type with a smaller number of bits than the number of bits defining the first precision level (e.g., smaller than the length of a 32-bit floating-point number), such as a half-precision (16-bit) floating-point number (float16), or a simpler data type, such as an integer data type of the same or smaller bit width (because integer math is less computationally complex compared to floating-point math). As described in operations 250, an independent frame (I-Frame) may be computed by convolving a first frame x_{I}⁽¹⁾ with kernel 202 yielding an output z_{I}⁽¹⁾ as described above with reference to FIG. 1. In some aspects, a subtraction operation 204 may be performed to compute a difference 254 between the first frame and a second frame x_{I}⁽²⁾, which is convolved with kernel 252 at a lower precision than that of kernel 202. In some aspects, this subtraction operation may be omitted (e.g., when the data stream is compressed, as discussed above). An addition operation 206 may be performed on the result 256 of the convolution and the output of the I-Frame z_{I}⁽¹⁾, yielding output z_{I}⁽²⁾. This procedure may be generalized to a t^{th} frame, where a difference 258 between a current frame and a previous frame x_{I}^{(t-1)} may be computed and convolved with kernel 252. The result 260 of the convolution may be added to the output of a previous frame, yielding output z_{I}^{(t)}. According to some aspects, the previous frame may be an I-Frame or a previous P-Frame.

In some aspects, in quantizing both keyframes and residual frames (or P-frames and I-frames), a uniform affine symmetric scheme may be used. The scale factor s may be based on the activation range of a quantizer, defined with a lower bound rₘᵢₙ and an upper bound rₘₐₓ, according to the equation:

$$s = s ( {r}_{max} , {r}_{min} ) = \frac{2 max ( {r}_{max} , {r}_{min} )}{{2}^{b - 1}}$$

At any convolution layer in a neural network used to generate a convolution z for an input x, different range setters may be used for quantizing the input x and a weight w. The range defined for weights may be based on a minimum weight and a maximum weight so that a quantized weight ŵ may be directly computed. For estimating the range of activations for input x, rₘᵢₙ^{x}, rₘₐₓ^{x}, a set of example inputs may be collected based on calibration samples input into a model. The example inputs may be concatenated into a batch X, and a line search space [symbol] between the minimum and maximum points in the batch X having r candidate points, according to the expression:

[symbol]

=linspace(min(X), max(X),r)

The range in [symbol] may be searched by minimizing, or at least reducing, the object function:

$${arg min}_{{r}_{max}^{x} , {r}_{min}^{x} ∈ 𝒮} {‖ X ( w - q ( X , Θ = s ( {r}_{max}^{x} , {r}_{min}^{x} ) ) * \hat{w} ‖}_{F}$$

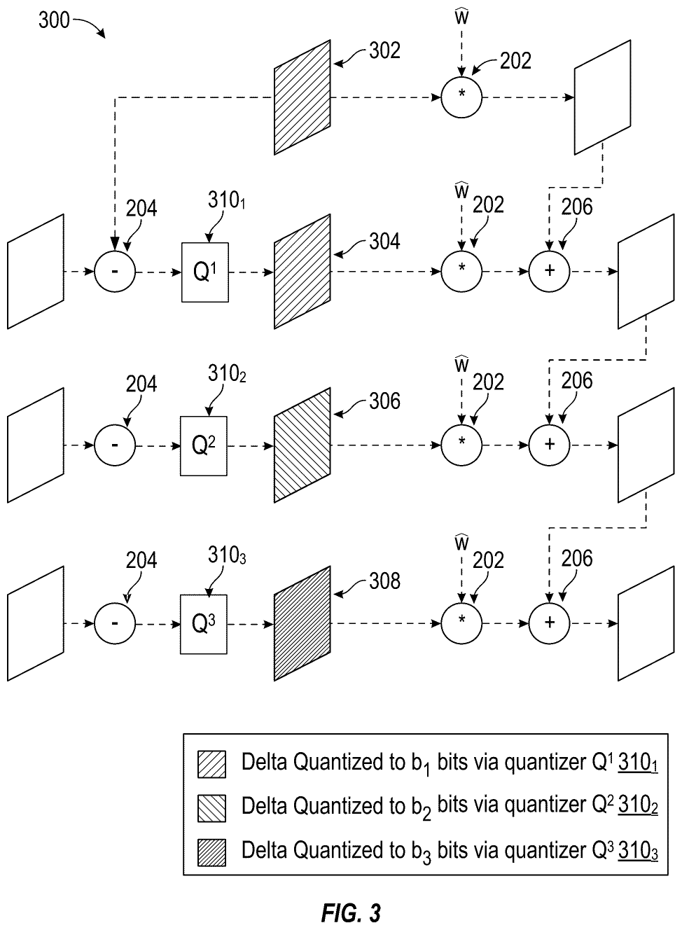

FIG. 3 illustrates example operations 300 for conditional delta quantization of different portions of a data stream based on a delta between these different portions, according to aspects of the present disclosure.

In a video stream, a distribution of deltas (e.g., with respect to an I-frame) changes over time. For example, deltas with respect to an I-frame may increase in magnitude as the time from the I-frame increases. For example, in a video stream having 60 FPS, each subsequent frame only captures changes that have occurred in the last 1/60^{th} of a second, which may be very small. However, as the time from an initial frame increases, the changes that have occurred relative to the initial frame may increase. This property (e.g., the correlation between time from the I-frame and magnitude of the delta with respect to the I-frame) may be exploited to reduce computational expense. For example, in some cases, computational efficiency may be improved by using less computationally expensive (e.g., complex) operations and data types when the time from the I-frame is small, and progressively transitioning to using more expensive operations with larger data types as the time from the I-frame increases.

Certain aspects of the present disclosure provide techniques for using a set of quantizers having different levels of precision (e.g., 8-bit, 4-bit, or 2-bit precision) for a particular delta. For example, during inference, a quantizer may be dynamically selected for use for a particular delta, based on the input frame. In some cases, a selected quantizer may be used globally for the frame.

In some cases, weights w may be quantized to ŵ, using some precision b_{w}. In some cases, I-frame activations are quantized to some precision bₐ with post training quantization (PTQ).

In some cases, different quantizers { [symbol] ¹, . . . , [symbol] ⁿ} 310 with precisions {bₐ¹, . . . , bₐⁿ} may be tailored for different magnitudes of deltas between successive frames. In other words, as described above, quantizers of varying precisions may be used for different frames, and the quantizers may be selected based on a magnitude of a difference (e.g., a delta) between different frames (which may correlate with a time from an initial frame, as described above).

In some cases, during calibration, each quantizer [symbol] ⁱ may be tailored independently by minimizing (or at least reducing) quantization noise on a calibration set δ in accordance with the following equation:

Qⁱ=argmin_{Q(⋅,b}_{ₐ}_{ⁱ}₎∥δw−Q(δ,bₐⁱ)ŵ∥

where Qⁱ represents an i^{th} quantizer, bₐⁱ represents an i^{th} precision (e.g., associated with the i^{th} quantizer), the argmin_{Q(⋅,b}_{ₐ}_{ⁱ}₎ operator represents a quantizer having minimum precision with an error that is “just small enough” (as described in greater detail below), δ represents a delta between frames, w represents weights (e.g., a kernel which may be a convolutional layer of some pre-trained neural network), Q(δ,bₐⁱ) represents a quantizer having precision bₐⁱ selected for the delta, and ŵ represents the weights w quantized to the i^{th} precision (e.g., precision bₐⁱ).

In some cases, during inference, a quantizer selection (e.g., which may be selected in order to provide sufficient resolution for the data being quantized while minimizing, or at least reducing, computational expense) may be a lower precision quantizer with an error that is below a threshold amount. This quantizer selection may be understood with reference to the following equation:

∥δŵ−Qⁱ(δ)ŵ∥=∥(δ−Qⁱ(δ))ŵ∥

The error of the i^{th} quantizer (∈ᵢ) may be approximated in accordance with the following equation:

∈ᵢ=∥δ−Qⁱ(δ)∥∥ŵ∥

In some cases, in order to select the precision at which data is quantized, and thus to select the quantizer to use in convolving the data of n configured quantizers, the difference in error Π may be thresholded to the next quantizer as shown in the following expression:

$$Π = {min}_{i = 1 , … , n} i such that {ϵ}_{i} - {ϵ}_{i + 1} < τ$$

In other words, if a difference in error is less than a threshold τ, a quantizer of lesser precision may be used in order to provide sufficient resolution (e.g., as defined based on a comparison between the error and the threshold τ) for the data being quantized while minimizing, or at least reducing, computational expense.

As illustrated in FIG. 3, the operations 300 for conditional delta quantization may include convolving an I-Frame 302 with a kernel 202 at a dynamically selected precision, using dynamically selected quantizers, to convolve different elements in a data stream and, in some aspects, convolve different portions of each element in the data stream. That is, the I-Frame may be quantized to b₁ bits as illustrated.

In some aspects, a subtraction operation 204 may be performed to compute a difference (e.g., a residual frame) 304 between the I-Frame and a next frame (e.g., a P-Frame). In some aspects, this subtraction operation may be omitted (e.g., when the data stream is compressed). In some aspects, for example, the residual frame may be pre-computed in a compressed data stream. After the residual frame is obtained (e.g., by the subtraction operation), the residual frame is convolved with a kernel 202 at a dynamically selected level of precision, which may be lower than the level of precision at which the first element (e.g., the I-Frame 302) is convolved. In this case, the residual frame is quantized to b₁ bits as illustrated, and the convolution result is added to the output of the previous convolution.

Next, a difference between a previous frame (e.g., the I-Frame or the previous P-Frame) and the current frame may be computed (or obtained) to yield a residual frame 306, which is convolved at a dynamically selected level of precision. As described above, in some aspects, the subtraction operation for computing the difference may be omitted (e.g., when the data stream is compressed). After the residual frame 306 is obtained, the residual frame is convolved with a kernel 202 at a dynamically selected level of precision. In this case, residual frame 306 is quantized to b₂ bits as illustrated, and the convolution result is added to the output of the previous convolution (after summation).

Next, a difference between a previous frame (e.g., the I-Frame or the previous P-Frame) and the current frame may be computed (or obtained) to yield a residual frame 308, which is convolved at a dynamically selected level of precision. As described above, in some aspects, the subtraction operation for computing the difference may be omitted (e.g., when the data stream is compressed). After the residual frame 308 is obtained, the residual frame is convolved with a kernel 202 at a dynamically selected level of precision. In this case, the residual frame 308 is quantized to b₃ bits as illustrated, and the convolution result is added to the output of the previous convolution (after summation).

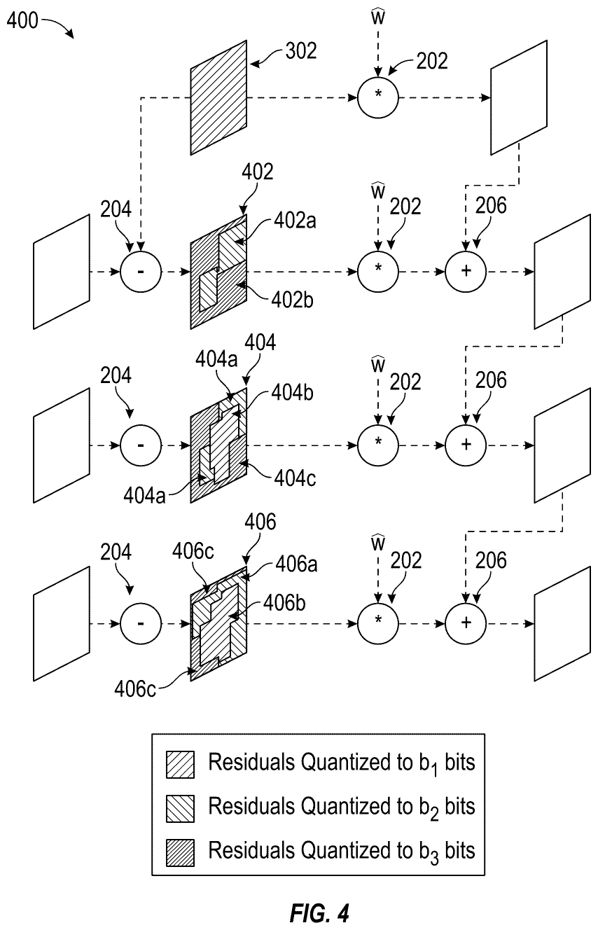

FIG. 4 illustrates example operations 400 for pixel-wise conditional delta quantization of different portions of a data stream based on a delta between these different portions, according to aspects of the present disclosure.

In a video, different regions (e.g., different sets of one or more pixels) in a delta frame may carry different amounts of information. In other words, different portions of a video frame may have different levels of redundancy relative to a previous frame. For example, deltas in foreground regions (e.g., which may be focused on constantly moving objects) may differ from deltas in background regions (e.g., which may be unchanging over time), and deltas in moving regions may differ from deltas in stationary regions. That is, in some cases, when compared to a previous video frame, background regions of a video frame may have greater redundancy than foreground regions of a video frame. In some cases, a set of quantizers 310₁-310ₙ having different precisions (e.g., 8-bit, 4-bit, or 2-bit precision) may be used to quantize different regions of the delta frame. Some regions might call for relatively high precision (e.g., moving regions). Some regions may call for relatively low precision (e.g., stationary regions).

As illustrated in FIG. 4, operations 400 for pixel-wise conditional delta quantization of various frames having one or more portions of pixels may include convolving an I-Frame 302 with a kernel 202 at a dynamically selected (as described above) level of precision, using dynamically selected quantizers, to convolve different elements in a data stream and, in some aspects, convolve different portions of each element in the data stream. That is, the I-Frame may be quantized to bi bits as illustrated.

In some aspects, a subtraction operation 204 may be performed to compute a difference (e.g., a residual frame 402) between the I-Frame and a next frame (e.g., a P-Frame). In some aspects, this subtraction operation may be omitted (e.g., when the data stream is compressed). In some aspects, for example, the residual (e.g., delta) frame may be pre-computed in a compressed data stream. After the residual frame 402 is obtained (e.g., by a subtraction operation), various portions of the residual frame may be convolved with a kernel 202 at various dynamically selected levels of precision, which may be lower than the level of precision at which the first element (e.g., the I-Frame 302) is convolved. In this case, portion 402a of the residual frame 402 is quantized to b₂ bits, and portion 402b of the residual frame 402 is quantized to b₃ bits as illustrated. The convolution result may then be added, via addition operation 206, to the output of the previous convolution.

Next, a difference between a previous frame (e.g., the I-Frame or the previous P-Frame) and the current frame may be computed (or obtained) to yield a residual frame 404, various portions of which may be convolved at various dynamically selected levels of precision. As described above, in some aspects, the subtraction operation for computing the difference may be omitted (e.g., when the data stream is compressed). As illustrated in this example, portions 404a of the residual frame 404 are quantized to b₂ bits, portion 404b of the residual frame is quantized to b₁ bits, and portion 404c of the residual frame is quantized to b₃ bits as illustrated. The convolution result may then be added to the output of the previous convolution.

Next, a difference between a previous frame (e.g., the I-Frame or the previous P-Frame) and the current frame may be computed (or obtained) to yield a residual frame 406, various portions of which may be convolved at various dynamically selected levels of precision. As described above, in some aspects, the subtraction operation for computing the difference may be omitted (e.g., when the data stream is compressed). As illustrated in this example, portion 406a of the residual frame is quantized to b₂ bits, portion 406b of the residual frame is quantized to b₁ bits, and portions 406c of the residual frame are quantized to b₃ bits as illustrated. The convolution result may then be added to the output of the previous convolution.

### Example Operations for Delta Quantization for Video Processing

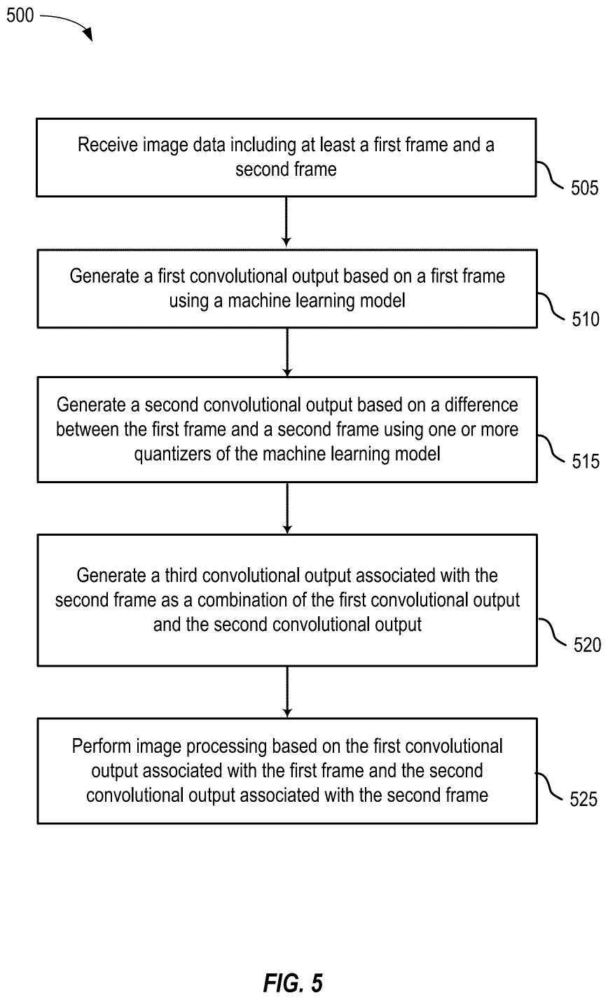

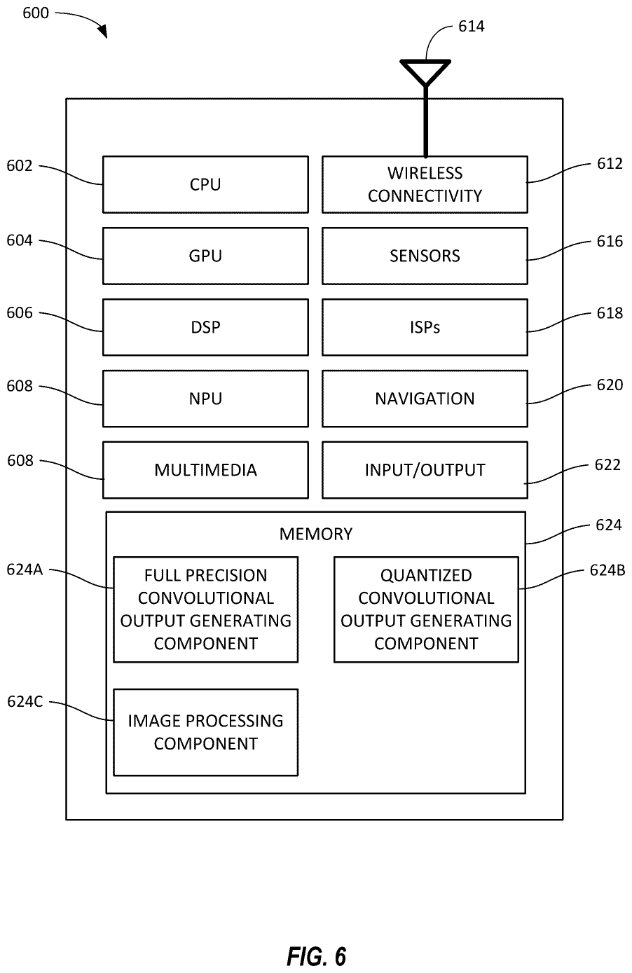

FIG. 5 shows an example of a method 500 for delta quantization for video processing, in accordance with aspects of the present disclosure. In some examples, the method 500 may be performed by a computing device such as the processing system 600 illustrated in FIG. 6.

As illustrated, method 500 begins at block 505 with receiving image data including at least a first frame and a second frame.

Method 500 then proceeds to block 510 with generating a first convolutional output based on a first frame using a machine learning model.

Method 500 then proceeds to block 515 with generating a second convolutional output based on a difference between the first frame and the second frame using one or more quantizers of the machine learning model.

Method 500 then proceeds to block 520 with generating a third convolutional output associated with the second frame as a combination of the first convolutional output associated with the first frame and the second convolutional output associated with the difference between the first frame and the second frame.

Method 500 then proceeds to block 525 with performing image processing based on the first convolutional output associated with the first frame and the third convolutional output associated with the second frame. These actions may include, for example, encoding of content into a latent space for compression, object detection in video content, subject pose estimation and movement prediction, semantic segmentation of video content into different segments, and the like.

In some aspects, the first convolutional output associated with the first frame is generated using a higher level of precision than a level of precision used to generate the second convolutional output based on the difference between the first frame and the second frame.

In some aspects, the higher level of precision comprises a floating-point representation at a given bit size. In some cases, the level of precision used to generate the second convolutional output (based on the difference between the first frame and the second frame) may comprise an integer representation at the given bit size. In other cases, the level of precision used to generate the second convolutional output may comprise an integer representation at a bit size smaller than the given bit size.

In some aspects, the first frame comprises a keyframe, which may be an initial frame including data for each spatial component in the initial frame of a video. Generally, a keyframe may include uncompressed data for each pixel (or spatial location) in the initial frame). In this case, generating the first convolutional output (associated with the first frame) may involve generating an output using full precision defined for the machine learning model.

In some aspects, the second frame comprises a delta frame including information about the difference between the first frame and the second frame. This delta frame may be smaller in size than the keyframe (or first frame), as the delta frame need not include information that is shared between the keyframe (or first frame) and the delta frame.

In some aspects, generating the second convolutional output includes selecting a quantizer from the one or more quantizers of the machine learning model based on a magnitude of the difference between the first frame and the second frame, wherein each quantizer of the one or more quantizers is associated with a different level of precision, and quantizing the difference between the first frame and the second frame using the selected quantizer.

In some aspects, selecting the quantizer involves selecting a smallest quantizer in which a difference in quantization error between the smallest quantizer and a larger quantizer is less than a threshold.

In some aspects, generating the second convolutional output includes, for each respective portion of the first frame and each respective corresponding portion of the second frame: selecting a quantizer from the one or more quantizers of the machine learning model based on a magnitude of the difference between the respective portion of the first frame and the respective corresponding portion of the second frame, wherein each quantizer is associated with a different level of precision, and quantizing the difference between the respective portion of the first frame and the respective corresponding portion of the second frame using the selected quantizer.

In some aspects, the respective portion of the first frame and the respective corresponding portion of the second frame correspond to a pixel (or to multiple pixels) in a same location in the first frame and the second frame.

### Example Processing Systems for Delta uantization for Video Processing

FIG. 6 depicts an example processing system 600 for delta quantization for video processing, such as described herein for example with respect to FIG. 5.

Processing system 600 includes a central processing unit (CPU) 602, which in some examples may be a multi-core CPU. Instructions executed at the CPU 602 may be loaded, for example, from a program memory associated with the CPU 602 or may be loaded from a memory 624.

Processing system 600 also includes additional processing components tailored to specific functions, such as a graphics processing unit (GPU) 604, a digital signal processor (DSP) 606, a neural processing unit (NPU) 608, a multimedia processing unit 610, a wireless connectivity component 612.

An NPU, such as NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the plurality of NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 612 is further coupled to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes full precision convolutional output generating component 624A, quantized convolutional output generating component 624B, and image processing component 624C. The depicted components, and others not depicted, may be configured to perform various aspects of the methods described herein.

Generally, processing system 600 and/or components thereof may be configured to perform the methods described herein.

Notably, in other aspects, aspects of processing system 600 may be omitted, such as where processing system 600 is a server computer or the like. For example, multimedia processing unit 610, wireless connectivity component 612, sensor processing units 616, ISPs 618, and/or navigation processor 620 may be omitted in other aspects. Further, aspects of processing system 600 may be distributed, such as training a model and using the model to generate inferences, such as user verification predictions.

### Example Clauses

Examples of various aspects of the present disclosure are described in the following numbered clauses:

Clause 1: A computer-implemented method, comprising: receiving image data including at least a first frame and a second frame; generating a first convolutional output based on a first frame using a machine learning model; generating a second convolutional output based on a difference between the first frame and a second frame using one or more quantizers of the machine learning model; generating a third convolutional output associated with the second frame as a combination of the first convolutional output and the second convolutional output; and performing image processing based on the first convolutional output associated with the first frame and the third convolutional output associated with the second frame.

Clause 2: The method of Clause 1, wherein the first convolutional output is generated using a higher level of precision than a level of precision used to generate the second convolutional output.

Clause 3: The method of Clause 2, wherein: the higher level of precision comprises a floating-point representation at a given bit size; and the level of precision used to generate the second convolutional output comprises an integer representation at the given bit size.

Clause 4: The method of Clause 2, wherein: the higher level of precision comprises a floating-point representation at a given bit size; and the level of precision used to generate the second convolutional output comprises an integer representation at a bit size smaller than the given bit size.

Clause 5: The method of any of Clauses 1-4, wherein: the first frame comprises a keyframe, and generating the first convolutional output comprises generating an output using full precision defined for the machine learning model.

Clause 6: The method of Clause 5, wherein: the second frame comprises a delta frame including information about the difference between the first frame and the second frame.

Clause 7: The method of any of Clauses 1-6, wherein generating the second convolutional output comprises: selecting a quantizer from the one or more quantizers of the machine learning model based on a magnitude of the difference between the first frame and the second frame, wherein each quantizer of the one or more quantizers is associated with a different level of precision; and quantizing the difference between the first frame and the second frame using the selected quantizer.

Clause 8: The method of Clause 7, wherein selecting the quantizer comprises selecting a smallest quantizer in which a difference in quantization error between the smallest quantizer and a larger quantizer is less than a threshold.

Clause 9: The method of any of Clauses 1-8, wherein generating the second convolutional output comprises, for each respective portion of the first frame and each respective corresponding portion of the second frame: selecting a quantizer from the one or more quantizers of the machine learning model based on a magnitude of the difference between the respective portion of the first frame and the respective corresponding portion of the second frame, wherein each quantizer is associated with a different level of precision; and quantizing the difference between the respective portion of the first frame and the respective corresponding portion of the second frame using the selected quantizer.

Clause 10: The method of Clause 9, wherein the respective portion of the first frame and the respective corresponding portion of the second frame correspond to a pixel in a same location in the first frame and the second frame.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any one of Clauses 1-10.

Clause 14: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown and/or described herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving image data including at least a first frame and a second frame;
generating a first convolutional output based on the first frame using a machine learning model;
generating a second convolutional output based on a difference between the first frame and the second frame using one or more quantizers of the machine learning model;
generating a third convolutional output associated with the second frame based on a combination of the first convolutional output and the second convolutional output; and
performing image processing based on the first convolutional output associated with the first frame and the third convolutional output associated with the second frame.

2. The method of claim 1, wherein the first convolutional output is generated using a higher level of precision than a level of precision used to generate the second convolutional output.

3. The method of claim 2, wherein:
the higher level of precision comprises a floating-point representation at a given bit size; and
the level of precision used to generate the second convolutional output comprises an integer representation at the given bit size.

4. The method of claim 2, wherein:
the higher level of precision comprises a floating-point representation at a given bit size; and
the level of precision used to generate the second convolutional output comprises an integer representation at a bit size smaller than the given bit size.

5. The method of claim 1, wherein:
the first frame comprises a keyframe, and
generating the first convolutional output comprises generating an output using full precision defined for the machine learning model.

6. The method of claim 5, wherein the second frame comprises a delta frame including information about the difference between the first frame and the second frame.

7. The method of claim 1, wherein generating the second convolutional output comprises:
selecting a quantizer from the one or more quantizers of the machine learning model based on a magnitude of the difference between the first frame and the second frame, wherein each quantizer of the one or more quantizers is associated with a different level of precision; and
quantizing the difference between the first frame and the second frame using the selected quantizer.

8. The method of claim 7, wherein selecting the quantizer comprises selecting a smallest quantizer in which a difference in quantization error between the smallest quantizer and a larger quantizer is less than a threshold.

9. The method of claim 1, wherein generating the second convolutional output comprises, for each respective portion of the first frame and each respective corresponding portion of the second frame:
selecting a quantizer from the one or more quantizers of the machine learning model based on a magnitude of the difference between the respective portion of the first frame and the respective corresponding portion of the second frame, wherein each quantizer is associated with a different level of precision; and
quantizing the difference between the respective portion of the first frame and the respective corresponding portion of the second frame using the selected quantizer.

10. The method of claim 9, wherein the respective portion of the first frame and the respective corresponding portion of the second frame correspond to a pixel in a same location in the first frame and the second frame.

11. A system, comprising:
a memory having executable instructions stored thereon; and
at least one processor configured to execute the executable instructions in order to cause the system to:
receive image data including at least a first frame and a second frame;
generate a first convolutional output based on the first frame using a machine learning model;
generate a second convolutional output based on a difference between the first frame and the second frame using one or more quantizers of the machine learning model;
generate a third convolutional output associated with the second frame based on a combination of the first convolutional output and the second convolutional output; and
performing image processing based on the first convolutional output associated with the first frame and the third convolutional output associated with the second frame.

12. The system of claim 11, wherein the first convolutional output is generated using a higher level of precision than a level of precision used to generate the second convolutional output.

13. The system of claim 12, wherein:
the higher level of precision comprises a floating-point representation at a given bit size; and
the level of precision used to generate the second convolutional output comprises an integer representation at the given bit size.

14. The system of claim 12, wherein:
the higher level of precision comprises a floating-point representation at a given bit size; and
the level of precision used to generate the second convolutional output comprises an integer representation at a bit size smaller than the given bit size.

15. The system of claim 11, wherein:
the first frame comprises a keyframe, and
in order to generate the first convolutional output, the at least one processor is configured to cause the system to generate an output using full precision defined for the machine learning model.

16. The system of claim 15, wherein the second frame comprises a delta frame including information about the difference between the first frame and the second frame.

17. The system of claim 11, wherein in order to generate the second convolutional output, the at least processor is configured to cause the system to:
select a quantizer from the one or more quantizers of the machine learning model based on a magnitude of the difference between the first frame and the second frame, wherein each quantizer of the one or more quantizers is associated with a different level of precision; and
quantize the difference between the first frame and the second frame using the selected quantizer.

18. The system of claim 17, wherein in order to select the quantizer, the at least one processor is configured to cause the system to select a smallest quantizer in which a difference in quantization error between the smallest quantizer and a larger quantizer is less than a threshold.

19. The system of claim 11, wherein in order to generate the second convolutional output, the at least one processor is configured to cause the system to, for each respective portion of the first frame and each respective corresponding portion of the second frame:
select a quantizer from the one or more quantizers of the machine learning model based on a magnitude of the difference between the respective portion of the first frame and the respective corresponding portion of the second frame, wherein each quantizer is associated with a different level of precision; and
quantize the difference between the respective portion of the first frame and the respective corresponding portion of the second frame using the selected quantizer.

20. The system of claim 19, wherein the respective portion of the first frame and the respective corresponding portion of the second frame correspond to a set of pixels in a same location in the first frame and the second frame.

21. A system, comprising:
means for receiving image data including at least a first frame and a second frame;
means for generating a first convolutional output based on the first frame using a machine learning model;
means for generating a second convolutional output based on a difference between the first frame and the second frame using one or more quantizers of the machine learning model;
means for generating a third convolutional output of the second frame as a combination of the first convolutional output and the second convolutional output; and
means for performing image processing based on the first convolutional output associated with the first frame and the third convolutional output associated with the second frame.

22. The system of claim 21, wherein the means for generating the first convolutional output is configured to use a higher level of precision than a level of precision than the means for generating the second convolutional output is configured to use.

23. The system of claim 22, wherein:
the higher level of precision comprises a floating-point representation at a given bit size; and
the level of precision the means for generating the second convolutional output is configured to use comprises an integer representation at the given bit size.

24. The system of claim 22, wherein:
the higher level of precision comprises a floating-point representation at a given bit size; and
the level of precision used to generate the second convolutional output comprises an integer representation at a bit size smaller than the given bit size.

25. The system of claim 21, wherein:
the first frame comprises a keyframe, and
the means for generating the first convolutional output comprises means for generating an output using full precision defined for the machine learning model.

26. The system of claim 25, wherein the second frame comprises a delta frame including information about the difference between the first frame and the second frame.

27. The system of claim 21, wherein the means for generating the second convolutional output comprises:
means for selecting a quantizer from the one or more quantizers of the machine learning model based on a magnitude of the difference between the first frame and the second frame, wherein each quantizer of the one or more quantizers is associated with a different level of precision; and
means for quantizing the difference between the first frame and the second frame using the selected quantizer.

28. The system of claim 27, wherein the means for selecting the quantizer comprises means for selecting a smallest quantizer in which a difference in quantization error between the smallest quantizer and a larger quantizer is less than a threshold.

29. The system of claim 21, wherein the means for generating the second convolutional output comprises, for each respective portion of the first frame and each respective corresponding portion of the second frame:
means for selecting a quantizer from the one or more quantizers of the machine learning model based on a magnitude of the difference between the respective portion of the first frame and the respective corresponding portion of the second frame, wherein each quantizer is associated with a different level of precision; and
means for quantizing the difference between the respective portion of the first frame and the respective corresponding portion of the second frame using the selected quantizer.

30. A non-transitory computer-readable medium having executable instructions stored thereon which, when executed by at least one processor, perform an operation comprising:
receiving image data including at least a first frame and a second frame;
generating a first convolutional output based on the first frame using a machine learning model;
generating a second convolutional output based on a difference between the first frame and the second frame using one or more quantizers of the machine learning model;
generating a third convolutional output associated with the second frame based on a combination of the first convolutional output and the second convolutional output; and
performing image processing based on the first convolutional output associated with the first frame and the third convolutional output associated with the second frame.
